(19) United States
(12) Patent Application Publication
(10) Pub. No.: US 2012/0176407 A1
(43) Pub. Date: Jul. 12, 2012

(54) METHOD FOR REPRESENTING A PLURALITY OF AT LEAST PARTIALLY OVERLAPPING OBJECTS

(75) Inventors: Sven Marco Hoppe, Oberursel (DE); Joachim Bader, Butzbach (Griedel) (DE)

(73) Assignee: DIEHL AEROSPACE GMBH, Uberlingen (DE)

(21) Appl. No.: 13/496,311

(22) PCT Filed: Sep. 3, 2010
(86) PCT No.: PCT/EP10/05424

§ 371 Date: Mar. 15, 2012

(30) Foreign Application Priority Data
Sep. 18, 2009 (DE) 10 2009 042 235.8

(51) Int. Cl. G09G 5/00

(52) U.S. Cl. 345/629

(57) ABSTRACT

In a method for representing a plurality of at least partially overlapping objects on a display device having a pixel matrix, wherein a distance value is associated with every object as a measure for a virtual distance to a viewer and the pixels of every object can be associated with an object region, a region priority value is associated with every object region. An object to be represented with a halo is subdivided into the object regions object core and the surrounding halo, the pixels of an object core being associated with a higher region priority value than the pixels of a halo. The pixels of an object without halo are associated with the object region ‘object surface’ with a lower region priority value than the pixels of a halo. In a preceding process step, the object region of the halo is initially treated and the object region of the object core is processed and displayed in a subsequent process step. A modified distance value is associated with every pixel being the sum of the original distance value multiplied by a region priority factor and the region priority value.

The invention relates to a method for representing a plurality of at least partially overlapping objects on a display device having a pixel matrix, wherein a distance value is associated with every pixel of an object as a measure for a virtual distance to a viewer and wherein the pixels of every object can be associated with an object region.

Images generated using electronic data processing systems are generally displayed on a display device having a pixel matrix whose individual pixels can be displayed in a purposeful manner. Such displays or monitors are also being used more frequently in vehicles or aircraft and serve to display information that is relevant or of particular importance for the operation and control of the vehicle or aircraft.

It is intended that all the information displayed is represented in a clear as possible manner and can be recognized quickly and unambiguously on the display devices used. At the same time, undesired changes during the period in which the information is represented are to be avoided, since they can have a disadvantageous effect on the concentration of the viewer. However, the use of individual pixels that predetermine the resolution of the display device frequently causes visible artifacts during the representation. For example, diagonal lines can have visibly stepped edges and by way of example horizontal lines noticeably change the width of the displayed pixels during a horizontal movement, which adversely affects the quality of the image.

In order to be able to generate and display graphic representations in vehicles and in particular in aircraft, which owing to the relevant requirements with regard to safety must meet stringent quality requirements, program languages and hardware components that have been tailored to suit and optimized in this respect have been developed and are characterized by being able to represent visually displayed information in a simple yet at the same time reliable manner and as naturally as possible. Whereas the software used for displaying information can be revised and continuously further developed at little cost, the development of new hardware components, in particular for civil and military aviation, is extremely costly.

It has been shown that, owing to rapidly progressing further development of the graphics hardware components for personal computers and electronic entertainment products, hardware components whose performance capabilities are at least equal to and frequently also superior to the hardware components that were especially developed for this purpose several years ago are now available at low cost and also in large numbers. However, such hardware components have not been designed and adapted to be able to process the specialized software that has been developed for a high quality graphic display.

In order to be able to avoid having to develop special hardware components that are ever increasingly more powerful and that are optimized for a high quality display of information and therefore compatible with the software that has been designed for this purpose, methods for representing graphic information are being developed and optimised that do not impose any special requirements on the hardware components required and that, by way of example, can also be used in conjunction with conventional graphics cards, graphics processors or graphic display devices.

It has proven satisfactory in practice to represent both flat objects and also lines or sets of lines by means of polygons that are provided with a texture. Anti-aliasing which is fundamentally necessary to improve the quality of the display can then be guaranteed in a simple manner by suitably selecting, specifying and using textures.

In order to be as independent as possible from the hardware components used in individual cases, when developing and creating new methods and programs, it is advantageous to be able to use standardized graphics programming languages, such as OpenGL. OpenGL allows the rapid display of polygons that can be optionally provided or represented with a predeterminable texture. The main features for calculating and displaying objects using the OpenGL programming language are described by way of example in “OpenGL Reference Manual”, Addison Wesley, 1997, ISBN 0-201-63276-4 and it is not intended to repeat these features here, with reference being made to the content of this publication in its entirety.

In the case of OpenGL, a new pixel matrix is prepared in parallel with a pixel matrix currently being represented, wherein the objects to be represented are processed pixel-by-pixel and a decision is made using a predetermined method procedure as to whether a pixel of an object must be represented or is hidden for example by objects that have already been processed, in order subsequently to tailor the pixel information accordingly in the new pixel matrix to be represented. As soon as the processing of the new pixel matrix to be represented is completed and all objects that are to be represented have been processed, the new pixel matrix to be represented can be displayed in order subsequently to be able to prepare afresh a subsequent new pixel matrix.

It has been shown and proven in practice, that it is advantageous in particular for representing information in civil and military aviation to provide or display some of the objects to be displayed with a halo. A halo that surrounds a core region of the object to be displayed and that, for example by means of brightening or a darker shading of the immediately surrounding area, enhances the contrast to the object to be displayed, clearly delimits this core region from the objects displayed immediately adjacent thereto and can be perceived more quickly and more reliably than is the case with objects that do not have a halo. For this reason, important information, such as co-ordinates, geographic directions or the relative position and orientation of a vehicle and in particular an aircraft is frequently displayed by lines or planar objects that are surrounded by a halo and are delimited from the information represented in the background.

The standardized graphics programming languages known from practice, such as OpenGL, cannot however readily display a halo that is intended to surround a line or a planar object, since no specific graphics commands exist for calculating and representing it. Therefore, the halo information must be managed and also a halo surrounding an object must be considered and displayed by means of appropriate methods in the respective software or application. Whereas it is possible with comparatively simple process steps to calculate and implement the display of objects that have a halo and that are situated at a different virtual distance from the viewer, experience has shown that the display of at least partially overlapping objects with a halo causes major problems, in particular as soon as the objects are at the identical virtual distance. In order to be able to consider the virtual distance in the representation, a distance value, also termed ‘priority’, is generally associated with every pixel of an object to be represented. The virtual distance becomes greater as the distance to the viewer increases, whereas the distance value is generally orientated or defined in the opposite direction and for objects at a greater virtual distance is lower than for objects at a shorter virtual distance. The pixel is then represented as a function of the distance value or on the basis of the distance value being compared with the distance values of possibly overlapping pixels. However, even when considering the virtual distance of the objects to be represented, a completely realistic representation of the objects is associated with a considerable amount of computing effort, so that approximations and defects in the representation regularly generally have to be accepted in order to be able to keep the time expended and the computational effort for generating the representation within acceptable limits.

The object of the present invention is thus to provide a method for representing a plurality of at least partially overlapping objects, with which method it is possible even when using standardized graphics programming languages, such as OpenGL, to represent objects with a surrounding halo rapidly and with a high visual quality.

This object is achieved in accordance with the invention by a method of the type mentioned in the introduction, wherein a region priority value is associated with every object region and wherein, in the case of overlapping objects with an identical distance value, only those pixels of a subsequently processed object whose region priority value is higher than or equal to the region priority value of the overlapping pixel of a previously processed object are displayed.

The association of individual pixels with object regions allows every pixel of an object to be provided with additional information, which facilitates a rapid and advantageous evaluation process and processing for displaying a halo that surrounds an object core. For this purpose, individual object regions can be allocated respectively individual textures, which in turn can be associated respectively with the pixels that are associated with these object regions and can be considered during their representation on the display device.

When calculating new pixel matrix to be represented, the criteria and process steps already known from practice, such as the depth test, anti-aliasing and the conventional frame-buffer-writing method including blending or mixing, can and should also be considered for the individual pixel information in order to improve the visual quality of the representation.

It is advantageous for an object that is to be represented with a halo to be subdivided into the object regions object core and surrounding halo. In order to prevent a halo of a subsequently processed object from overwriting an object core of a previously already processed object at an identical virtual distance from the viewer and from changing its representation, the region priority value of the object region ‘object core’ is predetermined in an expedient manner to be greater than the region priority value of the surrounding halo.

In particular with respect to the processing speed, it is advantageous that an object region ‘object surface’ with an accordingly uniform region priority value is associated with an object that is to be represented with a halo. It has been shown that by allocating a lower region priority value to the pixels of the object region ‘object surface’ than that allocated to the pixels of a halo, it is possible to achieve a representation of objects that are at least partially overlapping and where at least one object does not have a halo, which representation is particularly pleasing to the eye and at the same can also be calculated rapidly. In this way, it is possible, in the case of partially overlapping objects to prevent an incomplete halo being represented in the overlap area with objects without a halo; said incomplete halo would have a visible interruption in the overlap region with objects without a halo.

A visually appealing representation without distracting artifacts can be achieved in the case of objects with a halo in that in a preceding process step, the object region of the halo is initially processed and in a subsequent process step the object region ‘object core’ is processed and displayed.

A particularly advantageous embodiment of the inventive idea provides that a modified distance value is associated with every pixel, the said modified distance value being a sum of the original distance value multiplied by a region priority factor that can be set in advance and by the region priority value associated with this pixel, and that, for the representation of individual pixels, the modified distance value is considered and not the original distance value and the region priority value. The modified distance value accordingly considers the possible values for the region priority value and ensures that, in particular in the case of objects or pixels with a corresponding original distance value, the region priority value increases or reduces the original distance value without colliding with the adjacent original distance values.

If in the case of a method in accordance with the invention, for example, the region priority values 0, 1 and 2 are used, then a new modified distance value that is unique for every original distance value and for every region priority value can be calculated by multiplying the original distance value by the region priority factor 3, with the region priority value being added subsequently. The modified distance value differs irrespective of the respective region priority value for original distance values that are different from each other. At the same time, the respective region priority value is appropriately considered with the modified distance value.

When using the modified distance value, the standardized process steps and routines for calculating and representing a pixel can then be used, and a unique distance value is associated with this pixel. It is then no longer necessary to give separate consideration to the region priority value. By using standardized graphics display commands and by now being able to forego the separate process steps for calculating and displaying halo information it is possible to achieve a particularly rapid calculation of the new pixel matrix to be represented.

Various exemplary embodiments are described in the following text, wherein, in the drawings:

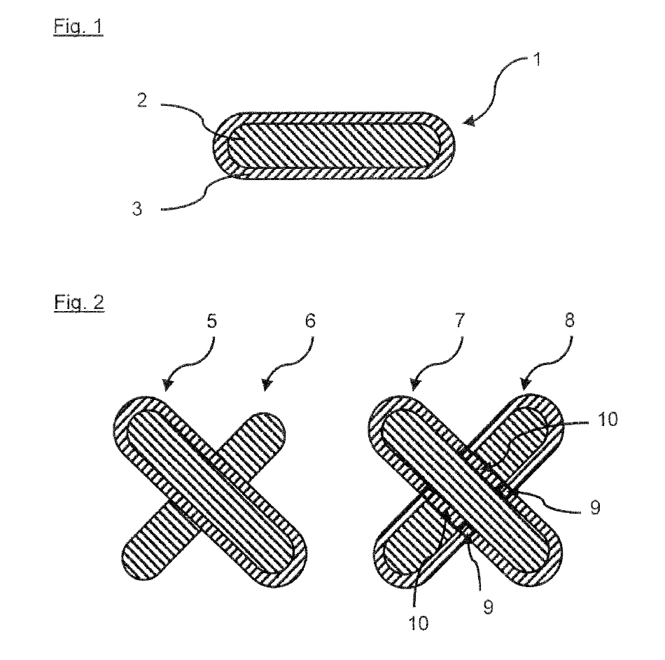

FIG. 1 is a schematic illustration of an object with an object region ‘object core’ and an object region ‘halo’,

FIG. 2 is a schematic illustration of various options for representing partially overlapping objects with and without a halo, as are known from the prior art,

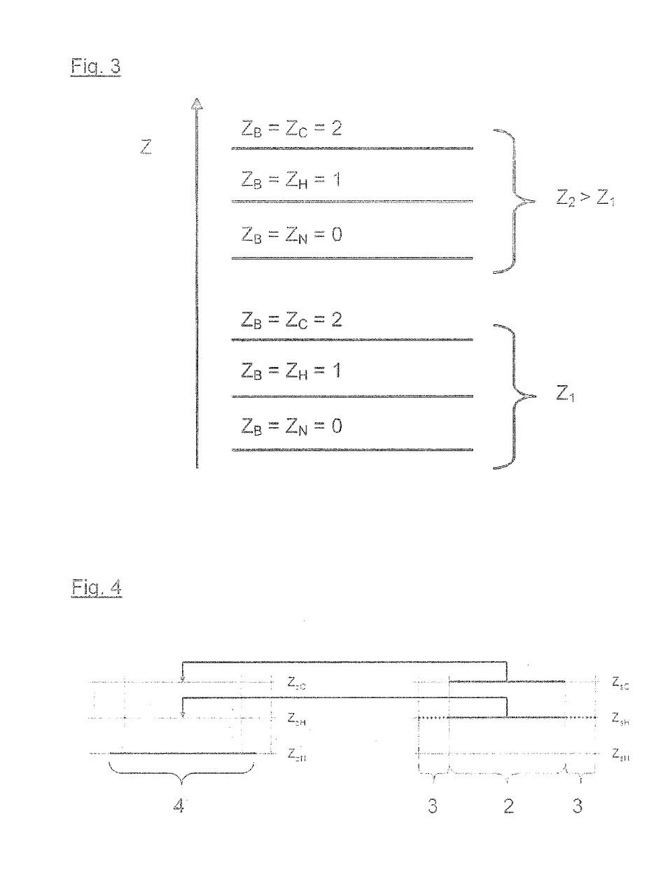

FIG. 3 is a schematic illustration of the possible association of individual object regions with the region priority values for each distance value,

FIG. 4 is a schematic illustration where individual pixels of the pixel matrix are checked and calculated, wherein an object without a halo and an object with a halo with the identical distance value overlap, for the object core of the subsequently processed object,

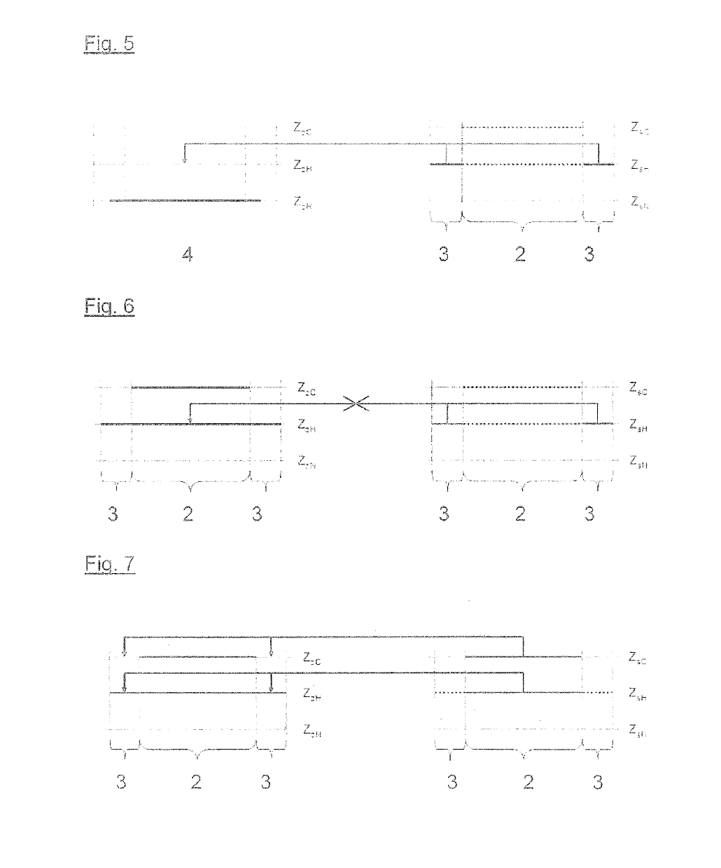

FIG. 5 is a schematic illustration where individual pixels of the pixel matrix are checked and calculated, wherein an object without a halo and an object with a halo with the identical distance value overlap, for the halo of the subsequently processed object,

FIG. 6 is a schematic illustration where individual pixels of the pixel matrix are checked and calculated, wherein two objects with a halo with the identical distance value overlap, for the halo of the subsequently processed object in the region of an object core of the previously processed object,

FIG. 7 is a schematic illustration where individual pixels of the pixel matrix are checked and calculated, wherein two objects with a halo with the identical distance value overlap, for the object core of the subsequently processed object in the region of the halo of the preceding object,

FIG. 8 is a schematic illustration where individual pixels of the pixel matrix are checked and calculated, wherein the subsequently processed object is at a shorter virtual distance from the viewer and thus as a higher distance value,

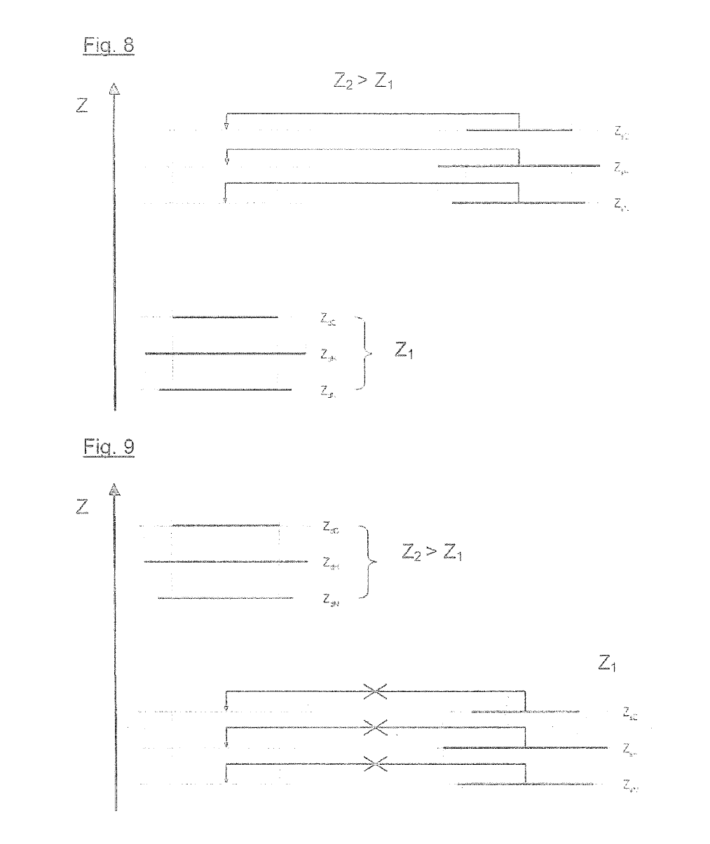

FIG. 9 is a schematic illustration where individual pixels of the pixel matrix are checked and calculated, wherein the subsequently processed object is at a greater virtual distance from the viewer and thus has a lower distance value, and

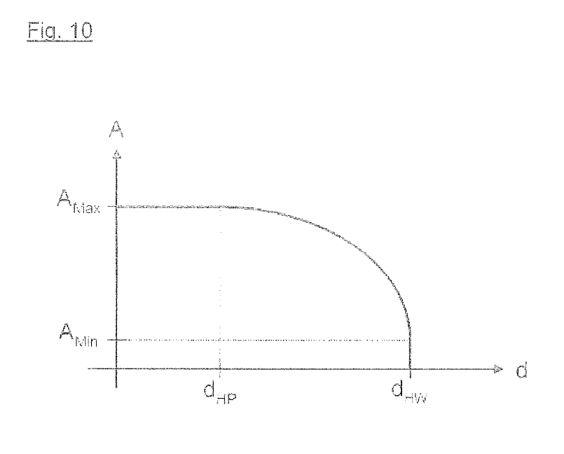

FIG. 10 is an exemplary profile of a texture-function f(d) that is suitable for the generation of or use with textures for individual object regions.

FIG. 1 shows a schematic illustration of an object (1) that is to be represented. The object (1) has two different regions, namely an object core X_{Core}(2) and a halo X_{Halo}(3) that surrounds the object core. Whereas an associated alpha value of the intensity for all pixels of the object core X_{Core}(2) is equal to or greater than a predetermined threshold value A_{Limit}, the associated alpha value for all pixels of the halo X_{Halo}(3) is lower than the threshold value A_{Limit}. In the case of an object (1) without a halo, there is no difference between these two object regions (2,3). The pixels are associated uniformly with an object region ‘object surface’ (X_{Line}) (4) and have an alpha value greater than zero.

Accordingly, the individual regions have the characteristics defined in the following formulae, where X represents the set of all associated pixels x with an associated alpha value f(x) between 0 and 1;

X_{Line}={x∈R²|ƒ(x)>0}

X_{Core}={x∈R²|ƒ(x)≧A_{Limit}}

X_{Halo}={x∈R²|0<ƒ(x)<A_{Limit}}

FIG. 2 illustrates, merely by way of example, two different illustrations of partially overlapping objects (5) and (6) or (7) and (8) with a respectively corresponding distance value; the representations have been displayed using the hitherto known standardized method. The method in accordance with the invention has not yet been considered, so that the artifacts and adverse effects that occur in the case of previous methods are visible in the representation.

In the example illustrated on the left-hand side, an object with a halo (5) is processed and displayed after an object without a halo (6). Since the distance value is identical, the pixels of the subsequently processed halo (3) of the object with a halo (5) are entered into the pixel matrix and overwrite the information of the previously processed object without a halo (6). If the object without a halo (6) were to be processed subsequently, then its pixels would overlap all the pixels of the object with a halo (5), to be precise regardless of its association with the object core (2) or with the halo (3) of this object with a halo (5). In the case of the respective illustrated representation of the objects (5) and (6), the sequence in which the objects (5) and (6) are processed is of importance and this sequence can often not be controlled. Such dependence causes unpredictable results in the representation and is fundamentally undesired, even if the display that randomly occurs in individual cases were to result in an acceptable representation.

In the example illustrated on the right-hand side, an object with a halo (7) is processed and displayed after an object (8) that likewise has a halo. Whereas in the overlapping regions (9) of the respective halo (3) the result of the representation need not appear displeasing to the eye, the halo (3) of the object with a halo (7) that has been processed and displayed subsequently would overwrite the object core (2) of the previously processed object with a halo (8) within an overlapping region (10), although both objects (7) and (8) are at an identical virtual distance from the viewer, and owing to the corresponding distance value no halo (3) of an object (7), (8) should overwrite or overlap and change the object core (2) of the respective other object (8), (7). Irrespective of the sequence in which the individual objects (7) and (8) have been processed, undesired artifacts would occur in the overlapping regions (10) of overlapping halos (3) and object cores (2).

Apart from in the illustrated examples, such artifacts and adverse effects in a visually appealing representation also occur in other combinations of at least partially overlapping objects with and without a halo.

In order to avoid these adverse effects and yet still be able to use standardized programming languages such as OpenGL, in contrast for the previously described examples from the prior art, the invention provides that a region priority value Z_{B} is associated with every pixel of an object (1) in addition to the predetermined distance value Z. The region priority value Z_{B} differs depending upon the respective object region—object core (2), halo (3) or object surface (4)—with which the relevant pixel is associated.

The region priority value Z_{B} is lowest for the region object surface (4), i.e. for objects (1) without a halo and can be for example Z_{B}=Z_{N}=0. The region priority value Z_{B} is higher for the region halo (3), for example Z_{B}=Z_{H}=1, and highest for the region object core (2), for example Z_{B}=Z_{C}=2. FIG. 3 illustrates schematically the region priority values Z_{B} (Z_{N}, Z_{H} and Z_{C}) that are available respectively for two different distance values Z₁ and Z₂.

In order to be able to calculate and display a well-defined representation of the objects (1), irrespective of the respective processing sequence of all the objects (1) to be displayed, the invention provides that the region priority value Z_{B} assigned to every pixel is considered when calculating the new pixel matrix to be displayed. A pixel (Index d) that has a distance value Z_{d} and a region priority value Z_{dB} and has already been entered in the pixel matrix will then be overwritten by a pixel of a subsequently processed object (1) (Index s), only if its distance value Zₛ is higher or if, in the case of an identical distance value Zₛ, its region priority value Z_{SB} is higher than or equal to the region priority value Z_{dB} that has already been recorded in the pixel matrix.

FIGS. 4 to 7 clearly illustrate by way of example different case scenarios, in which respective different object regions with the respective region priority values Z_{N}<Z_{H}<Z_{C} of objects (1) are processed successively, overlapping and have an identical distance value Z are considered.

If a pixel of an object (1) without a halo, i.e. a pixel with a region priority value Z_{B}=Z_{dN} has already been entered into the new pixel matrix to be represented, then pixels from the halo (3) and from the object core (2) of a subsequently processed object (1) with the respective region values Z_{sH} or Z_{sC} can overlap this pixel and are processed, or are entered into and recorded in the new pixel matrix to be represented using conventional algorithms (FIG. 4 or FIG. 5).

If a pixel of an object (1) with an object core (2) and a halo (3) with the respective region priority values Z_{dH} and Z_{dC} has already been recorded in the new pixel matrix to be represented, then a pixel from the object region of the halo (3) of a subsequently processed object (1) with a region priority value Z_{sH}<Z_{dC} cannot overlap a pixel that has already been recorded from the object core (2) with the region priority value Z_{dC} and is not subjected to any further processing or further consideration (FIG. 6).

In the case of an identical starting position, pixels from an object core (2) with a region priority value Z_{sC} or pixels from the halo (3) with a region priority value Z_{sH} can fundamentally overwrite pixels that have already been recorded from the halo (3) of an already processed object (1), the reason being that its region priority value is either Z_{dH}<Z_{sC} for the halo (3) or Z_{dH}=Z_{sH} for the object core (2) and is thus lower than or equal to the new region priority value (FIG. 7). A pixel from the halo (3) with a region priority value Z_{sH} can overlap at least pixels that have already been recorded from the halo (3) of an object (1) that has already been processed, since in this case Z_{dH}=Z_{sH}.

In contrast to the cases previously described, FIGS. 8 and 9 illustrate for clarity the situation where objects (1) are at a different virtual distance from the viewer. In FIG. 8, a subsequently processed object (1) is virtually closer to the viewer and therefore has a higher distance value Z₂ than the object (1) that has already been recorded and has a distance value Z. Irrespective of whether the closer object (1) has a halo (3), all object regions—object core (2), halo (3) or object surface (4)—can each overlap the pixels that have already been recorded. In contrast thereto, the subsequently processed object (1) in FIG. 9 is at a greater virtual distance and thus a lower distance value Z₂<Z₁ than the object (1) already recorded, so that the subsequently processed object (1) is fundamentally not considered and is ignored. The respective region priority values are in these cases not relevant for processing the objects (1) and therefore do not cause any delay during processing.

Experiments have shown that it is possible to calculate partially overlapping objects (1) as quickly as possible and to discern said objects in a pleasing manner by associating textures with individual object regions. Separate textures can be used for the respective regions—object core X_{Core} (2) and halo X_{Halo} (3) in the case of an object (1) with a halo and object surface X_{Line} (4) in the case of an object (1) without a halo—and can be allocated to these object regions. The textures, the alpha values within the respective regions and in particular the textures and alpha values at the edges of the regions are predetermined in an appropriate manner in order to produce a visually appealing representation.

Any texture function f(d) known for example from practice and whose dependence upon predeterminable parameters can if necessary also be determined empirically and recorded in a table format can be used in all cases for the textures of individual lines. A schematic and merely exemplary profile of such a texture function f(d) is illustrated in FIG. 10. The texture function f(d) is in this case a function of the line width d and amongst other things is dependent upon parameters such as the width d_{HP} with the maximum alpha value A_{Max} and also the maximum width d_{HW}, where the alpha value A is close to or equal to zero. Other texture functions that can be determined numerically or empirically and recorded in the form of algorithms or tables are also known from practice and can be used to represent the objects.

In accordance with the invention, the texture for the halo (3) of the object (1) is in this case initially considered for every object (1) to be newly processed and its representation is prepared in the new pixel matrix to be newly represented, and the object region of the object core (2) or its texture is subsequently processed in a subsequent process step.

1. A method for representing a plurality of at least partially overlapping objects on a display device having a pixel matrix, wherein a distance value is associated with every object as a measure for a virtual distance to a viewer and wherein the pixels of every object can be associated with an object region, comprising
associating a region priority value with every object region and, in the case of overlapping objects with an identical distance value, displaying only those pixels of a subsequently processed object whose region priority value is higher than or equal to the region priority value of the overlapping pixel of a previously processed object.

2. The method as claimed in claim 1, wherein
an object that is to be represented with a halo is subdivided into the object regions object core and surrounding halo.

3. The method as claimed in claim 2, wherein
a higher region priority value is associated with the pixels of an object core than with the pixels of a halo.

4. The method as claimed in claim 1, wherein
an object region ‘object surface’ with a uniform region priority value is associated with an object that is to be represented without a halo.

5. The method as claimed in claim 4, wherein
a lower region priority value is associated with the pixels of an object region ‘object surface’ than with the pixels of a halo.

6. The method as claimed in claim 2, wherein
in a preceding process step, the object region of the halo is initially processed and in a subsequent process step the object region ‘object core’ is processed and displayed.

7. The method as claimed in claim 1, wherein
a modified distance value is associated with every pixel, the said modified distance value being a sum of the original distance value multiplied by a region priority factor and the region priority value and that, for the representation of individual pixels, the modified distance value is considered and not the original distance value and the region priority value.

8. The method as claimed in claim 1, wherein
a depth test and a conventional frame-buffer-writing method including a blending or mixing process for the individual pixel information are considered.
